(19) United States
(12) Patent Application Publication
(10) Pub. No.: US 2018/0044116 A1
(43) Pub. Date: Feb. 15, 2018

(54) VIBRATING FEEDER CONTROL APPARATUS AND VIBRATING FEEDER

(71) Applicant: SINFONIA TECHNOLOGY CO., LTD., Tokyo (JP)

(72) Inventor: Ryo Kawai, Tokyo (JP)

(73) Assignee: SINFONIA TECHNOLOGY CO., LTD., Tokyo (JP)

(21) Appl. No.: 15/554,993

(22) PCT Filed: Feb. 26, 2016
(86) PCT No.: PCT/JP2016/055824

§ 371 Date: Aug. 31, 2017

(30) Foreign Application Priority Data
Mar. 5, 2015 (JP) 2015-043986

(51) Int. Cl. B65G 27/32; H02P 25/032; H02P 27/12; B65G 27/24; H02K 33/02

(52) U.S. Cl. CPC B65G 27/32; B65G 27/24; H02K 33/02; H02P 27/12; H02P 25/032; B65G 2812/0312

(57) ABSTRACT

A vibrating feeder control apparatus used for driving a vibrating feeder main body (1) includes a base (11), a movable body (12) elastically supported by the base, an electromagnet (14) provided on the base, and a magnetic core (15) provided on the movable body to oppose the electromagnet. The PWM signal generation unit (33) generates a PWM signal based on a set drive frequency (f) and applies a pseudo AC voltage corresponding to the PWM signal to the electromagnet. The current detection unit (34) detects a current flowing in the electromagnet by a pseudo AC voltage. The current change rate generation unit (35, 36) generates a current change rates (R_{θ1}, R_{θ2}) at a predetermined reference phase angle (θ1, θ2) within one cycle of the pseudo AC voltage. The frequency correction unit (37) corrects the drive frequency based on a current change rate at a reference phase angle.

### TECHNICAL FIELD

The present invention relates to a vibrating feeder control apparatus for operating a vibrating feeder main body having an electromagnet as a driving source, and a vibrating feeder including the vibrating feeder control apparatus.

### BACKGROUND ART

As a conventional vibrating feeder for conveying a work by utilizing vibration, there has been known a so-called linear feeder, which linearly vibrates a movable body and linearly conveys a work on a movable body (refer to Patent Literature 1), and a so-called bowl feeder, which conveys a work along the inner wall of a bowl by generating torsional vibration by twisting a bowl as a movable body to put a work in (refer to Patent Literature 2).

Although they are different in a vibrating direction, a movable body is elastically supported on a base to be easily displaced in a specific direction, and a driving force is given to the movable body side, whereby the above-mentioned linear vibration and torsional vibration can be generated in the movable body.

An electromagnet is often used as a driving source because of its low and easy control. By performing ON/OFF control of a current flowing in an electromagnet, a desired vibration can be generated in the movable body. However, harmonics and chatter often occur only by applying a simple pulse voltage to the electromagnet, and it is preferable to apply a sinusoidal AC voltage to perform quiet and smooth control. Further, in order to drive at a desired frequency, there is another way to generate a pseudo AC voltage using a PWM (Pulse Width Modulation) circuit, and supply the generated voltage to the electromagnet.

Further, for obtaining a large displacement, while reducing the energy supplied to the electromagnet, as well as applying an AC voltage of a frequency close to a resonance frequency of the vibrating feeder main body to the electromagnet, a so-called resonance point follow-up control may be performed, which causes the frequency of AC voltage to follow the resonance frequency changing constantly according to the weight and position of a work to be conveyed (see Patent Literature 2).

### CITATION LIST

### Patent literature

Patent Literature 1: Japanese Unexamined Patent Application Publication No. 3-106711

Patent Literature 2: Japanese Patent No. 4066480

### SUMMARY OF THE INVENTION

### Problems to be Solved by the Invention

However, in the conventional vibrating feeder including the above-described Patent Literature 2, for performing the resonance point follow-up control, it is necessary to provide a displacement sensor for detecting a displacement of the movable body on the vibrating feeder main body side. The control apparatus for driving the vibrating feeder main body is configured to control a drive frequency by determining whether a resonance state is established based on an output from the displacement sensor.

That is, for performing such a resonance point follow-up control, it is assumed that the displacement sensor is provided on the vibrating feeder main body side, which leads to an increase in the size and manufacturing cost of an apparatus to incorporate the displacement sensor. In addition, since it is necessary to connect the displacement sensor and the control apparatus with a cable, it takes time and labor for the wiring, and it is also necessary to take into account the possibility of failure due to disconnection or the likes.

Furthermore, for adding the function of the resonance point follow-up control to the existing vibrating feeder main body having no displacement sensor and appropriately control a movable body, it is necessary not only to update the control apparatus but also to add a displacement sensor to the vibrating feeder, requiring a large cost.

It is an object of the present invention to effectively solve such a problem, and in particular, to provide a vibrating feeder control apparatus of simple wiring and high reliability, which can control a drive frequency at which a phase difference between a voltage and a displacement becomes a predetermined relationship even when no displacement sensor is provided on the vibrating feeder main body side, and an inexpensive vibrating feeder using this control apparatus.

### Solution to Problem

The present invention takes the following measures in order to achieve the above object.

That is, a vibrating feeder control apparatus of the present invention is an apparatus used for driving a vibrating feeder main body comprising a base, a movable body elastically supported by the base, an electromagnet provided on one of the base and the movable body, and a magnetic core provided on the other of the base and the movable body to oppose the electromagnet. The control apparatus comprises a PWM signal generation unit that generates a PWM signal based on a set drive frequency and applies a pseudo AC voltage corresponding to the PWM signal to the electromagnet, a current detection unit that detects a current flowing in the electromagnet by the pseudo AC voltage, a current change rate generation unit that generates a current change rate at a predetermined reference phase angle within one cycle of the pseudo AC voltage based on a detection value of the current detection unit, and a frequency correction unit that corrects the drive frequency based on a current change rate at a reference phase angle obtained by the current change rate generation unit.

With this configuration, by applying the pseudo AC voltage corresponding to the PWM signal generated by the PWM signal generation unit to the electromagnet, a pulse-like constant voltage is applied to the electromagnet in a short time. When a constant voltage is applied to the electromagnet in this way, the current change rate that is a gradient of the current flowing through the electromagnet corresponds to an inductance of the electromagnet. Since this inductance corresponds to a gap between the electromagnet and the magnetic core, in other words, a displacement amount of the movable body, obtaining the current change rate is to be regarded as knowing the displacement amount of the movable body at that point in time. Therefore, the current change rate generation unit generates a current change rate at a predetermined reference phase angle, and the frequency correction unit corrects a drive frequency based on the current change rate, whereby even when the displacement sensor for detecting a displacement of the movable body is not provided in the vibrating feeder main body, it is possible to control the drive frequency so that the phase difference between the voltage and the displacement becomes a predetermined relationship, and to realize a vibrating feeder with simple wiring, high reliability and low manufacturing cost.

To enable control of a drive frequency for more properly driving the vibrating feeder, it is preferable that a first reference phase angle and a second reference phase angle are set as the reference phase angle at positions that are substantially symmetrical around a phase angle at which a peak value of the pseudo AC voltage occurs, a first current change rate generation unit that generates a first current change rate corresponding to the first reference phase angle, and a second current change rate generation unit that generates a second current change rate corresponding to the second reference phase angle are provided as the current change rate generation unit, and the frequency correction unit is configured to correct the drive frequency based on the first and second current change rates obtained from the first and second current change rate generation units.

Further, for generating a current change rate easily and accurately when a constant voltage is being applied, it is preferable to configure the current change rate generation unit to generate the current change rate during a period from turn-on to turn-off of the PWM signal for one pulse corresponding to the first and second reference phase angles.

For obtaining a current change rate more accurately by avoiding the influence of a response delay immediately after switching to turn on the PWM signal, it is preferable to configure the current change rate generation unit to generate the current change rate during a period from turn-on of the PWM signal for one pulse corresponding to the first and second reference phase angles to turn-off after a lapse of predetermined time.

For easily realizing the resonance point follow-up control, it is preferable that the first reference phase angle is set to a range over −90° and below 0° and the second reference phase angle is set to a range over 0° and below 90° when a phase angle at which a peak value of the pseudo AC voltage occurs is assumed to be 0°, and the frequency correction unit does not correct a drive frequency when a current change rate difference obtained by subtracting an absolute value of the second current change rate from an absolute value of the first current change rate is within a predetermined range including a zero therebetween, and corrects the drive frequency in a decreasing direction when the current change rate difference exceeds the predetermined range, and corrects the drive frequency in an increasing direction when the current change rate difference is smaller than the predetermined range.

For realizing an inexpensive vibrating feeder with simple wiring and high reliability, it is preferable to configure to include the vibrating feeder control apparatus described in any one of the above and a vibrating feeder main body controlled by the vibrating feeder control apparatus.

### Effect of the Invention

According to the present invention described above, it is possible to provide a vibrating feeder control apparatus with simple wiring and high reliability, which is capable of controlling a drive frequency at which a phase difference between a voltage and a displacement becomes a predetermined relationship even when no displacement sensor is provided on the vibrating feeder main body side, and an inexpensive vibrating feeder using this control apparatus.

### BRIEF DESCRIPTION OF THE DRAWINGS

FIG. 1 is a configuration diagram schematically showing a vibrating feeder according to an embodiment of the present invention.

FIG. 2 is an explanatory view schematically showing an electromagnetic drive unit provided in the vibrating feeder.

FIG. 3 is an explanatory view showing a relationship when voltage and current supplied to the electromagnetic drive unit are enlarged.

FIG. 4 is an explanatory diagram showing a relationship between voltage and current supplied to the electromagnetic driving unit and displacement for each vibration mode.

FIG. 5 is an explanatory view showing a case where voltage and current supplied to the electromagnetic driving unit are enlarged in the vicinity of a reference phase angle.

FIG. 6 is an explanatory view showing a way of thinking about correction of a drive frequency of the electromagnetic drive unit.

FIG. 7 is an explanatory diagram schematically showing an example of actual waveforms of voltage and current.

FIG. 8 is an explanatory diagram showing an example, when voltage and current are actually measured.

### MODE FOR CARRYING OUT THE INVENTION

Hereinafter, one embodiment of the present invention will be described with reference to the drawings.

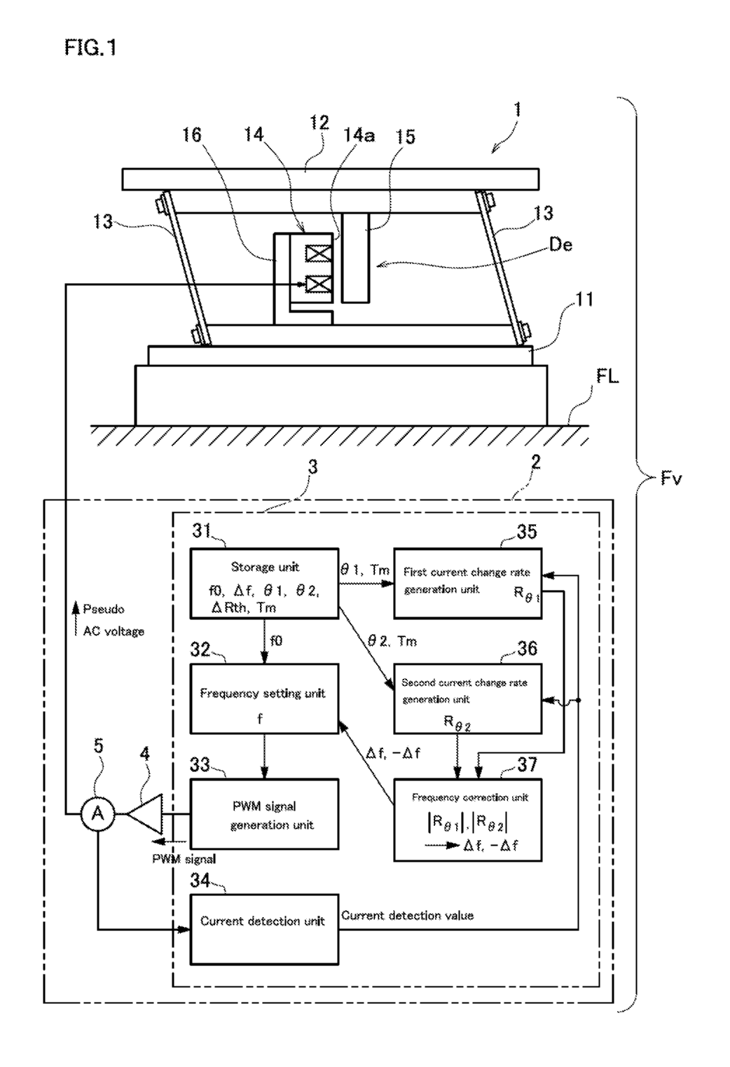

As shown in FIG. 1, a vibrating feeder Fv of this embodiment is configured as a so-called linear feeder comprising a vibrating feeder main body 1 and a vibrating feeder control apparatus 2 (hereinafter referred to as a “control apparatus 2”).

The vibrating feeder main body 1 can convey a work (not shown) placed on a movable body 12 by vibrating the movable body 12 in a longitudinal direction (width direction of the paper). That is, the longitudinal direction of the movable body 12 is set in the same direction as the work conveying direction.

The vibrating feeder main body 1 is configured as follows to vibrate the movable body 12.

The vibrating feeder main body 1 includes a base 11 installed on a floor surface FL and a movable body 12 connected to the base 11 via a pair of leaf springs 13, 13 which are elastic support means. An elastic support means such as an anti-vibration rubber or the like may be provided between the base 11 and the floor surface FL. The leaf springs 13, 13 is disposed parallel to each other while being separated in the longitudinal direction of the movable body 12 (in the left-right direction of the paper) so that they are inclined slightly upward. Therefore, the movable body 12 is elastically supported on the base 11 while being displaceable in a direction perpendicular to the surfaces of the leaf springs 13, 13, that is, in a slightly inclined direction including components in the longitudinal and vertical directions of the movable body 12.

The vibrating feeder main body 1 further includes an electromagnetic drive unit De to be able to vibrate the movable body 12 in the above-described displaceable direction. Specifically, the, electromagnetic drive unit De comprises an electromagnet 14 and a magnetic core 15. The electromagnet 14 is provided on the base 11 through a bracket 16 to be disposed with a magnetic attraction surface 14 an orthogonal to a horizontal direction. The magnetic core 15 has a rectangular plate shape and is fixed to the lower surface of the movable body 12 to extend downward. Being configured as above, the electromagnet 14 and the magnetic core 15 are disposed opposite to each other to generate a magnetic attraction force therebetween by a current flowing in the electromagnet 14, thereby displacing the movable body 12.

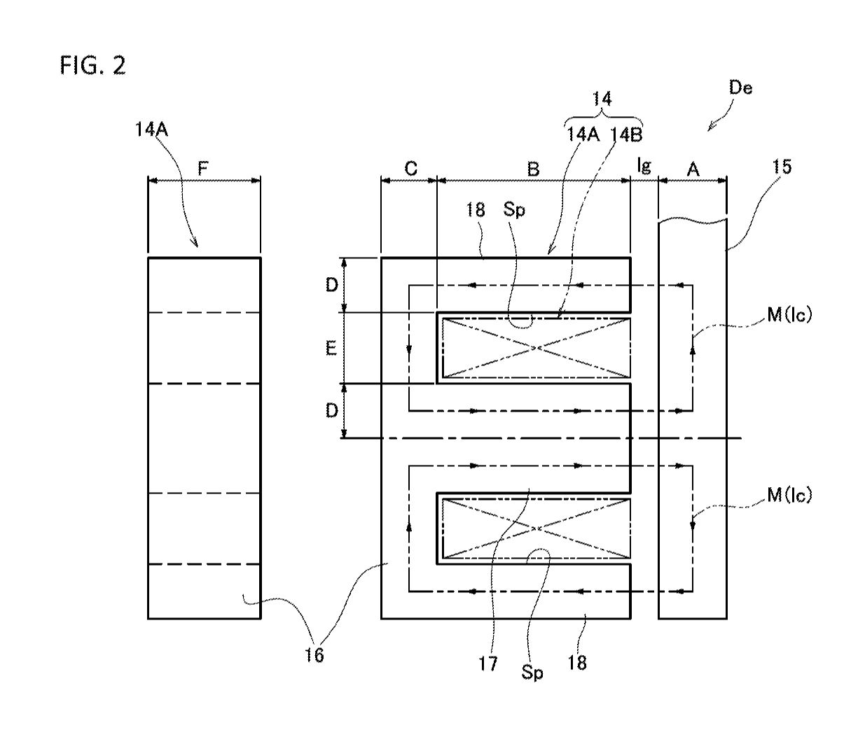

FIG. 2 is an enlarged view of the electromagnetic drive unit De. FIG. 2(b) shows a state viewed from the same direction as FIG. 1. FIG. 2(a) shows a state where the electromagnet 14 is viewed from the opposite side of the magnetic core 15.

The electromagnet 14 comprises an iron core 14A and a coil 14B. In FIG. 2(a), the coil 14B is omitted, and in FIG. 2(b), it is indicated by an imaginary line (two-dot chain line). The magnetic core 15 and the iron core 14A are formed by laminating and integrating silicon steel plates that are ferromagnetic materials.

The iron core 14A is formed to have an E-shape in a side view, and includes a rectangular back plate 16 extending in the vertical direction, a center protrusion 17 having a rectangular shape in a plan view extending to the magnetic core 15 from the center in the vertical direction, and a pair of outer protrusions 18, 18 having a rectangular shape in a plan view and extending toward the magnetic core 15 from the upper and lower ends of the back plate 16.

Between the center protrusion 17 and each of the outer protrusions 18, 18, two internal spaces Sp and Sp are formed opening sideways and toward the magnetic core 15. The coil 14B is configured to wind around the center protrusion 17 while straddling the two internal spaces Sp, Sp.

Being configured as above, when an electric current flows in a coil 14B, as shown by an arrow in the figure, two magnetic paths M are formed to pass through the inside of the magnetic core 15 from the center projection part 17 and return to the center protrusion 17 via the outer protrusion 18 and the back plate 16. Thereby a magnetic attraction force is generated between the electromagnet 14 and the magnetic core 15. In order to form the magnetic path M in such a direction, it is necessary to make the current flowing through the coil 14B counterclockwise as viewed from the magnetic core 15 side. When a current flows in the opposite direction, a magnetic path is formed in the opposite direction to the above.

Returning to FIG. 1, a sinusoidal AC voltage is applied from the control apparatus 2 to the electromagnet 14 constituting the electromagnetic drive part De, and a current corresponding to this flows, whereby a sinusoidal magnetic attraction force is generated between the base 11 and the movable body 12, and this magnetic attraction force becomes an exciting force for the movable body 12 to cause a vibration in the movable body 12.

The control apparatus 2 for controlling the vibrating feeder main body 1 configured as described above is configured as follows.

First, the control apparatus 2 includes an information processing unit 3, an amplifier 4 that amplifies a PWM signal output from the information processing unit 3 to generate a drive voltage and supplies the drive voltage to the electromagnet 14, and a current detector 5 that detects a current flowing from the amplifier 4 to the electromagnet 14.

The information processing unit 3 is constituted by an ordinary microprocessor or the like having a CPU, a memory, and an interface. The memory has previously stored a program necessary for processing. The CPU successively takes out and executes a necessary program to achieve a desired function by cooperating with peripheral hardware resources.

The information processing unit 3 includes a storage unit 31, a frequency setting unit 32, a PWM signal generation unit 33, a current detection unit 34, a first current change rate generation unit 35, a second current change rate generation unit 36, and a frequency correction unit 37, so that so-called resonance point follow-up control can be performed by cooperation of these components even thought a displacement detection signal is not input from the vibrating feeder main body 1 side.

The storage unit 31 stores an initial setting frequency f0 for driving the electromagnetic drive unit De on startup, first and second reference phase angles θ1 and θ2 to be described later, a threshold value ΔRth of a current change rate difference ΔR used for frequency correction, a frequency correction amount Δf per one time, and a mask time Tm and the likes.

The frequency setting unit 32 sets a drive frequency f for driving the electromagnetic drive unit De, and outputs the drive frequency f to the PWM signal generation unit 33. The frequency setting unit 32 reads an initial set frequency f0 stored in the storage unit 31 and uses the value as the drive frequency f upon startup of operation, and sequentially updates the drive frequency f based on a frequency correction value input from the frequency correction unit 37 described later after entering steady operation.

Based on the drive frequency f input from the frequency setting unit 32, the PWM signal generation unit 33 generates a PWM signal to obtain a sinusoidal pseudo AC voltage signal corresponding to the drive frequency f. The PWM signal consists of a rectangular positive voltage pulse signal and a negative voltage pulse signal as viewed to expand in minute time units. A pseudo AC voltage signal is generated by output of these pulse signals while changing a duty ratio, that is, while changing a pulse width. As described above, the PWM signal is amplified by the amplifier 4 and supplied to the electromagnet 14 as a drive voltage.

The current detection unit 34 can detect a current value flowing in the electromagnet 14 in real time by an input from the current detector 5 and output it as a current detection value.

The first current change rate generation unit 35 generates a first current change rate R_{θ1} at a first reference phase angle θ1 from the current detection value detected by the current detection unit 34. The second current change rate generation unit 36 generates a second current change rate R_{θ2} at a second reference phase angle θ2 from the current detection value detected by the current detection unit 34.

The frequency correction unit 37 compares absolute values |R_{θ1}|, |R_{θ2}| of the current change rates R_{θ1}, R_{θ2} generated by the current change rate generation units 35, 36. Based on the comparison result, the frequency correction unit 37 determines whether or not to correct the drive frequency f and further whether to increase or decrease a current value of the drive frequency f when correcting the drive frequency f, and outputs a corresponding frequency correction value Δf or −Δf.

Specifically, when the current change rate difference ΔR obtained by subtracting the absolute value |R_{θ2}| of the second current change rate R_{θ2} from the absolute value |R_{θ1}| of the first current change rate R_{θ1} is determined to be within a range ±ΔRₜₕ set by the predetermined threshold value ΔRₜₕ, since it is in the resonance state, the frequency correction unit 37 outputs a zero frequency correction value to the frequency setting section 32 without requiring frequency correction. In that case, the frequency setting unit 32 maintains a current value of the drive frequency f without making corrections.

When the current change rate difference ΔR is determined to be smaller than the above range, that is, smaller than −ΔRₜₕ, the frequency correction unit 37 outputs the frequency correction value Δf to the frequency setting unit 32 to add the frequency correction amount Δf for one time stored in the storage unit 31 to a current value of the drive frequency f as determined in advance. In that case, the frequency setting unit 32 corrects the drive frequency f to set a new drive frequency f+Δf.

Further, when the current change rate difference ΔR is determined to exceed the above range, that is, larger than ΔRₜₕ, the frequency correction unit 37 outputs the frequency correction value −Δf to the frequency setting unit 32 to subtract the frequency correction value Δf for one time from a current value of the drive frequency f. In that case, the frequency setting unit 32 corrects the drive frequency f to set a new drive frequency f−Δf.

Here, in order to explain the operation of the control apparatus 2 configured as described above, the principle of the resonance point follow-up control made by the control apparatus 2 will be described.

When a voltage V is applied to the electromagnetic drive unit De configured as shown in FIG. 2, a relation as shown by the following equation occurs between the current change rates di/dt (=R) representing a gradient of a current flowing in the coil 14B.

di/dt=V/L (Equation 1)

Here, dt is a minute time, di is a current change value during a minute time dt, and L is an inductance. From Equation 2, it can be seen that the current change rate di/dt is inversely proportional to the inductance L when the voltage is constant.

Further, the inductance L has the following relation with the magnetic path M through which a magnetic flux passes by the electromagnet 14.

L=μ₀·S·N²/(l_{g}+l1_{c}/μᵣ) (Equation 2)

Here, μ₀ so is a permeability in vacuum (=4π×10⁻⁷), μᵣ is a relative magnetic per (=15000) of a silicon steel plate forming the iron core 14A and the magnetic core 15, l_{c} is a length of the magnetic path M, S is a cross-sectional area of the iron core 14A.

As shown in FIG. 2, it is assumed that the thickness of the magnetic core 15 is A, the length of the center protrusion 17 and the outer protrusion 18 is B, the thickness of the back plate 18 is C, the thickness of the outer protrusion 18 is D, and the thickness of the center protrusion 17 is set to 2×D. Further, it is assumed that the space between the center protrusion 17 and the outer protrusion 18 is E, and the width dimension of the core 14A and the magnetic core 15 is F. In that case, if a gap formed between the iron core 14A constituting the electromagnet 14 and the magnetic core 15 is l_{g}, the length l_{c} of the magnetic path M can be obtained from the following equation.

l_{c}=A+2B+C+2D+2E+2l_{g} (Equation 3)

Further, a sectional area S of the iron core 14A can be obtained from the following equation.

S=D×F (Equation 4)

As can be seen from Equation 2, the inductance L is influenced by the permeability μ₀ of the vacuum, the sectional area S, the number of turns N, the gap l_{g}, the magnetic path length l_{c}, and the relative permeability μᵣ. Among them, a variable is only the gap lg and the magnetic path length lc. According to Equation 3, an influence of a change in the gap lg that can be given to the inductance L is much greater than an influence of a change in the magnetic path length lc. That is, the change in the inductance L occurs mostly due to the change in the gap lg.

Therefore, if a voltage is constant, the inductance L can be obtained from the current change rate di/dt according to Equation 1, and the gap l_{g} can be obtained by Equation 2. Further, qualitatively, it can be said that the gap l_{g} is constant when the current change rate di/dt is constant,the gap l_{g} is small when the current change rate di/dt is relatively small, and the gap l_{g} is large when the current change rate di/dt is relatively large. Since a change in the gap l_{g} means a displacement of the movable body 12 (see FIG. 1), by obtaining the current change rate di/dt in a certain minute time, a displacement of the movable body 12 can be obtained without requiring a special displacement sensor.

Further, since the positive or negative of the current change rate di/dt changes only depending on the positive or negative of the applied voltage, it has little meaning in obtaining the displacement of the movable body 12. Therefore, a magnitude relationship of the current change rate di/dt may be determined by |di/dt| with an absolute value.

Generally, a sinusoidal AC voltage is applied to the electromagnetic drive unit De (see FIG. 1) used for the vibrating feeder, and a pseudo AC voltage by PWM control is often used for such an AC voltage. The present embodiment adopts this system.

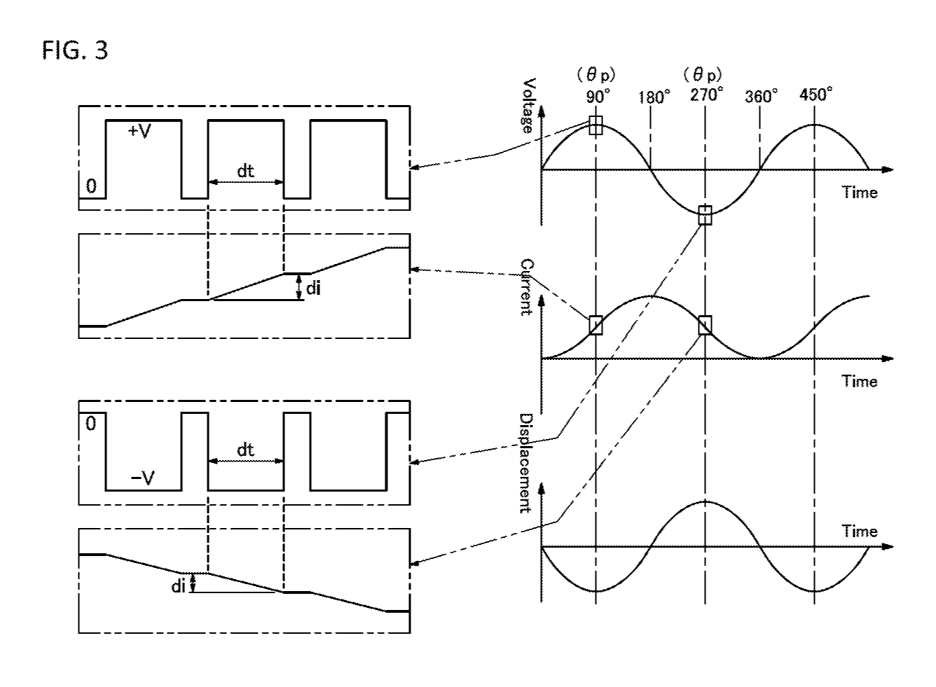

FIG. 3 shows waveforms of a pseudo AC voltage used in the present embodiment and a current to flow in the electromagnet 14 when this voltage is applied. A part of the waveform is shown on the right side, and a magnified one is shown on the left side.

In the PWM control, a constant voltage of rectangular pulse shape is output by changing the pulse width and further by reversing positive and negative every half cycle. By collecting such a pulsed voltage, a sinusoidal pseudo AC voltage is created. Incidentally, the pulse width becomes the largest at a point of phase angle 90° where a positive peak value of a sine wave is obtained or at a point of phase angle of 270° where a negative peak value is obtained. On the contrary, the pulse width becomes the smallest at points of phase angles 0° and 180°.

By applying the pseudo AC voltage created in this way, a current flows only in one direction with respect to the electromagnet 14, and the current value sinusoidally changes at the same frequency as a voltage. At this time, the current is accompanied by a phase angle delay of 90° with respect to the voltage. In order to obtain such a relationship between the voltage and the current, the known circuit configuration as described in Japanese Patent No. 4032192 can be effectively utilized.

When viewing the voltage and current having such a relationship by enlarging a minute time, the voltage forms a rectangular wave pulse voltage, and the current changes stepwise corresponding to the pulse voltage. For example, when paying attention to the point of phase angle 90° corresponding to the positive peak value of the voltage, the voltage is constant while one pulse voltage is being applied, and a gap l_{g} of the electromagnetic drive unit De hardly changes and can be regarded as constant in the minute time dt during which this pulse voltage is obtained. Thus, the current change rate R (=di/dt) during that time is substantially constant. Likewise, even when paying attention to the point of phase angle 270° corresponding to the negative peak value of the voltage, the current change rate R (=di/dt) during that time is substantially constant.

However, as will be described in detail later, when an AC voltage is applied to the electromagnetic drive unit De (see FIG. 1) for vibration, the movable body 12 becomes a resonance state, and the phases of the AC voltage and displacement re reversed 180°. Therefore, the absolute value |R| (=|di/dt|) of the current change rate increases at the phase angle of 90°, because as the movable body 12 displaces in a negative direction and the gap l_{g} increase, and the absolute value |R| (=|di/dt|) of the current change rate decreases at the phase angle is 270°, because the movable body 12 displaces in a positive direction and the gap l_{g} decreases.

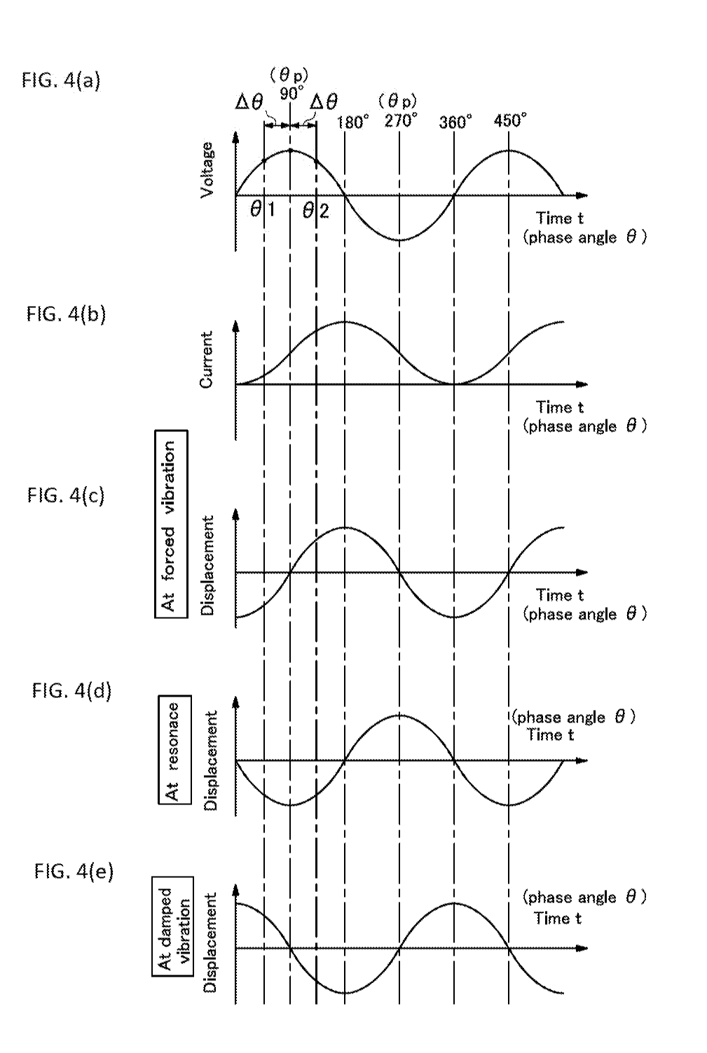

Here, the relationship between the voltage applied to the electromagnetic drive unit De and the displacement of the movable body 12 will be described. FIG. 4 illustrates how the phase of displacement changes in accordance with a vibration form of the movable body 12.

When a sinusoidal AC voltage as shown in FIG. 4(a) is applied to the electromagnetic drive unit De (see FIG. 1), as shown in FIG. 4(b), a current whose phase is delayed by 90° from the voltage flows. Since a magnetic attraction force proportional to a current is generated in the electromagnetic drive unit De, the movable body 12 is vibrated by this magnetic attraction force with the same phase as the current. Then, as shown in FIG. 4(c), when a vibration form of the movable body 12 is in a forced vibration state, the displacement of the movable body 12 changes with the same phase as an exciting force, that is, the current. When the vibration form is in a damped vibration state as shown in FIG. 4(e), the displacement of the movable body 12 changes with a phase of 180° opposite to the current. Furthermore, in a resonance state as shown in FIG. 4(d), the displacement of the movable body 12 changes with a phase of 90° delayed from the current (exciting force).

Viewing this as a relationship between the voltage and displacement, the displacement phase delays by 90° with respect to the voltage during the forced vibration, the displacement phase delays by 270° with respect to the voltage during the damped vibration, and the displacement phase delays by 180° with respect to the voltage during the resonance.

Therefore, when setting a first reference phase angle θ1 and a second reference phase θ1 at positions symmetrical with respect to a phase angle θp at which a voltage peak value is obtained (hereinafter referred to as a “peak phase angle θp”), for example θp=90°, that is, when setting the first and second reference phase angles θ1, θ2 to satisfy the relationship of θ1=θp−Δθ, θ2=θp+Δθ, a displacements at these positions are equal at resonance and different at forced vibration and damped vibration.

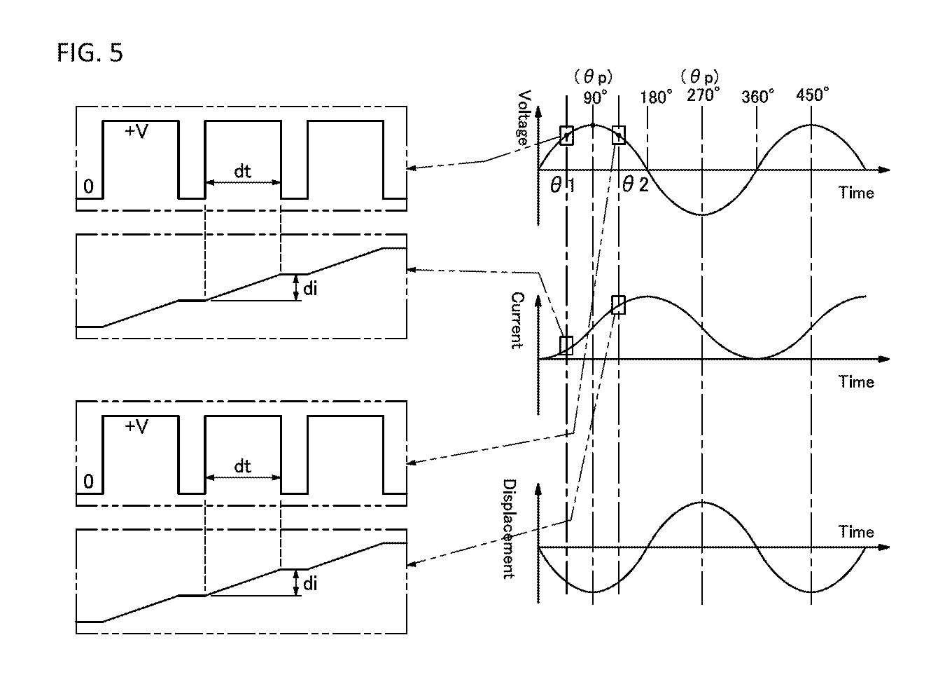

Considering this fact in combination with the above-described relation with the current change rate R (=di/dt), the following relation is obtained. FIG. 5 shows the relationship between the voltage and the current at the first and second reference phase angles θ1 and θ2.

As can be seen from the figure, since the first and second reference phase angles θ1 and θ2 are located symmetrically with respect to the peak phase angle θp, the pulse widths are substantially the same. Furthermore, since the momentary displacement values are equal at the first and second reference phase angles θ1, θ2, the current change rate R (=di/dt) corresponding to this pulse width is also equal. Therefore, the current change amount di corresponding to one pulse voltage is also equal.

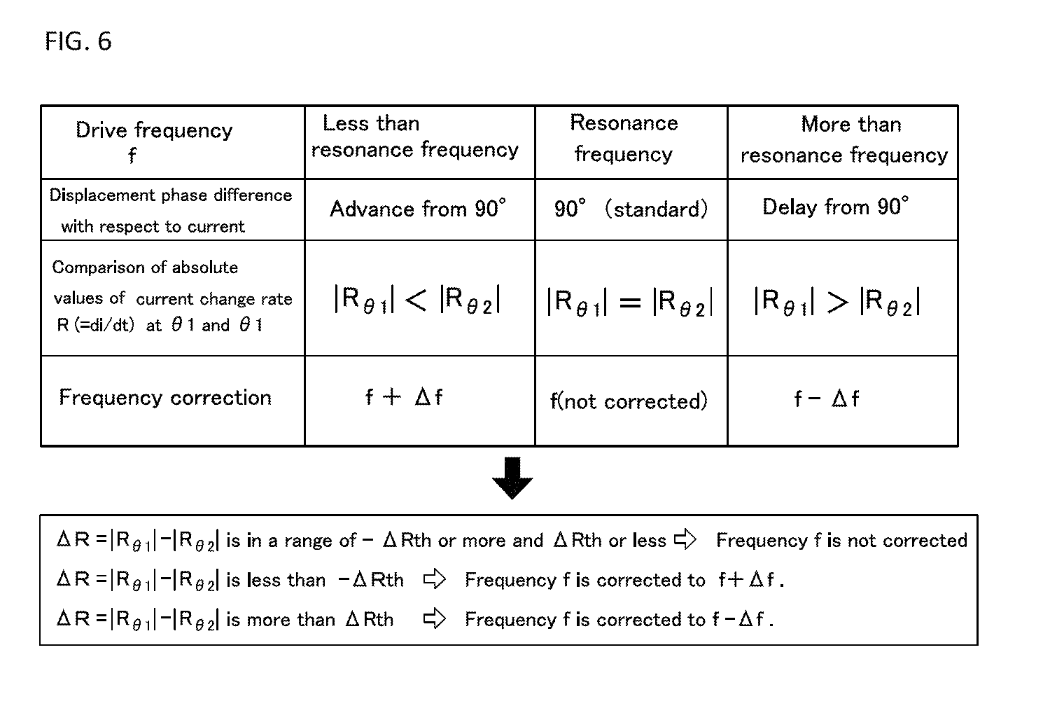

The table shown in the upper part of FIG. 6 shows a theoretical relationship between the first current change rate R_{θ1}, which is a current change rate R at the first reference phase angle θ1, and the second current change rate R_{θ2}, which is a current change rate R at the second reference phase angle θ2, in each case when the drive frequency f for driving the movable body 12 (see FIG. 1) coincides with the resonance frequency, the case when it is lower than the resonance frequency, and the case when it exceeds the resonance frequency. The description shown in the lower part of FIG. 6 shows a relationship to be used in actual control based on the above theoretical relationship.

Specifically, as shown in the table in the upper part of FIG. 6, when the drive frequency f coincides with the resonance frequency, as described above, the phase difference between the current and the displacement is 90°, and the absolute value |R_{θ1}| of the first current change rate is equal to the absolute value |R_{θ2}| of the second current change rate. When performing the resonance point follow-up control, correction of the drive frequency f is unnecessary in such a case.

When the drive frequency f deviates to less than the resonance frequency from this state, a displacement phase difference with respect to a current advances from 90°. At this time, the absolute value |R_{θ1}| of the first current change rate is smaller than the absolute value |R_{θ2}| of the second current change rate. Therefore, when performing the resonance point follow-up control, the drive frequency f may be corrected in an increasing direction to f+Δf.

On the other hand, when the drive frequency f deviates in a direction exceeding the resonance frequency, the displacement phase difference between a current and a displacement delays from 90°. At this time, the absolute value |R_{θ1}| of the first current change rate is larger than the absolute value |R_{θ2}| of the second current change rate. Therefore, when performing the resonance point follow-up control, the drive frequency f may be corrected in a decreasing direction to f−Δf.

In practice, however, it is difficult to shape a pulse voltage to a perfect rectangle, and it is difficult to change a current completely linearly while one pulse voltage is being output.

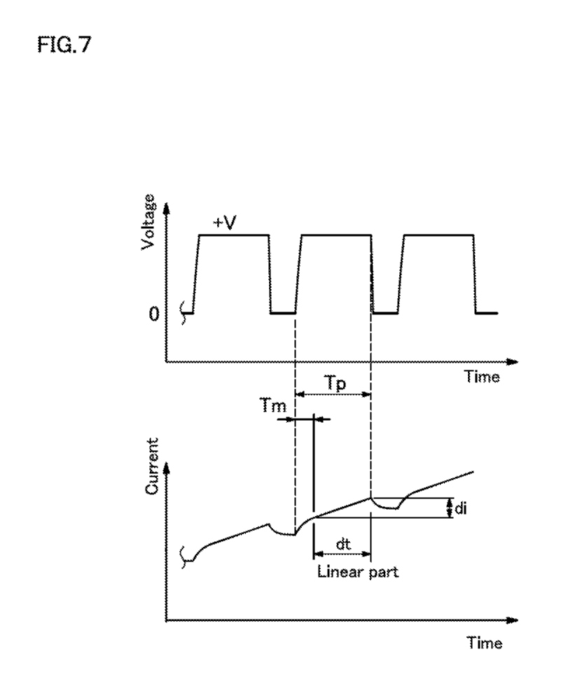

FIG. 7 schematically shows characteristics of the waveforms of actually obtained voltage and current. Like this, when switching a voltage signal from an off state (0) to an on state (+V), the voltage rises with a slight inclination due to a response delay immediately after the switching. Then, after maintaining a constant state, the voltage returns to the off state with a slight inclination. Likewise, a current rises dully due to a response delay immediately after the switching, and changes linearly with a certain inclination after gradually changing on a curve. Then, as the voltage switches to OFF, the current turns to decrease.

In other words, while a pulse signal is being output, the current change rate R (=di/dt) is not always constant. However, after a predetermined masking tame Tm has elapsed from immediately after the switching at which a pulse signal turns on, the inclination can be considered to be substantially constant, and the above-described relationship can be seen in this linear part. Therefore, a portion obtained by subtracting the mask time Tm from the pulse output time Tp is set as a minute time dt for generation of the current change rate R, and the current change rate di therebetween is obtained, and the current change rate R (=di/dt) may be generated from these values.

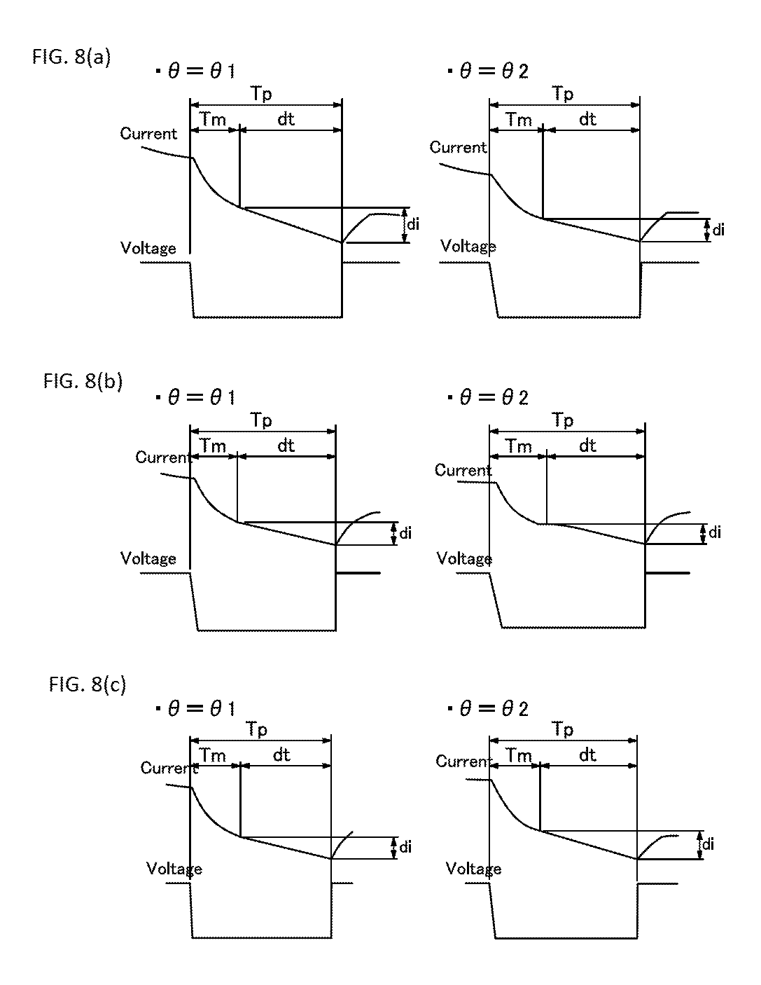

FIG. 8 shows enlarged waveforms of actually measured pulse voltage and current, and an example of a case where the current change rate R (=di/dt) is obtained by the above method from these waveforms. In these waveforms, since the first reference phase angle θ1 and the second reference phase angle θ2 are set within a range of ±90° around the phase angle 270° where the pseudo AC voltage is a negative peak value, the enlarged waveforms of the voltage and the current are upside down with respect to FIG. 7.

First, FIG. 8(a) shows enlarged waveforms of the voltage and current obtained when the drive frequency f is higher than the resonance frequency. At the first reference phase angle θ1, the current change amount is di=1.33 mA with respect to the minute time dt=22.8 μsec, and the absolute value of the first current change rate |R_{θ1}|=58.7 is obtained. At the second reference phase angle θ2, the current change amount is di=0.83 mA with respect to the minute time dt=21.7 μsec, an absolute value of the second current change rate |R_{θ2}|=38.3 is obtained. In this case, the current change rate difference ΔR=20.4 obtained by subtracting the absolute value |R_{θ2}| of the second current change rate from the absolute value |R_{θ1}| of the first current change rate is considerably large, about 35% of the absolute value |R_{θ1}| of the first current change rate.

FIG. 8(b) shows enlarged waveforms of the voltage and current obtained when the drive frequency f coincides with the resonance frequency. At the first reference phase angle θ1, the current change amount is di=0.79 mA with respect to the minute time dt=21.3 μsec, and the absolute value |R_{θ1}|=37.3 of the first current change rate is obtained. At the second reference phase angle θ2, the current change amount is di=0.75 mA with respect to the minute time dt=22.0 μsec, an absolute value of the second current change rate |R_{θ2}|=34.1 is obtained. In this case, the current change rate difference ΔR=3.2 obtained by subtracting the absolute value |R_{θ2}| of the second current change rate from the absolute value |R_{θ1}| of the first current change rate is approximately 9% of the absolute value |R_{θ1}| of the first current change rate, that is almost zero. In other words, it can be said that the absolute values |R_{θ1}| and |R_{θ2}| of the current change rate are substantially equal.

FIG. 8(c) shows enlarged waveforms of the voltage and current obtained when the drive frequency f is lower than the resonance frequency. At the first reference phase angle θ1, the current change amount is di=0.71 mA with respect to the minute time dt=19.2 μsec, and the absolute value of the first current change rate |R_{θ1}|=36.8 is obtained. At the second reference phase angle θ2, the current change amount is di=1.04 mA with respect to the minute time dt=20.7 μsec, and the absolute value of the second current change rate |R_{θ2}|=50.2 is obtained. In this case, the current change rate difference ΔR=−13.4 obtained by subtracting the absolute value |R_{θ2}| of the second current change rate from the absolute value |R_{θ1}| of the first current change rate is considerably small, about −36% of the absolute value |R_{θ1}| of the first current change rate.

According to the above actually measured waveforms, the mask time Tm is set to 10 to 15 μsec in the control apparatus 2 of the present embodiment. Further, in order to determine whether or not to correct the drive frequency f, the threshold value ΔRth is set for comparing the current change rate difference ΔR that is the difference between the absolute values |R_{θ1}|, |R_{θ2}| of each current change rate, and this threshold value ΔRₜₕ is set to 10% of the absolute value |R_{θ1}| of the first current change rate. Moreover, when the current change rate difference ΔR is in a range of over −ΔRₜₕ and below +ΔRₜₕ that is set with zero interposed therebetween, the drive frequency f is not corrected, but corrected only when the current change rate difference is out of this range. More specifically, when the current change rate difference ΔR is less than −ΔRₜₕ, the drive frequency f is corrected to be high, and when the current change rate difference ΔR exceeds ΔRₜₕ, the drive frequency f is corrected to be low.

In the control apparatus 2, even when no displacement sensor is provided in the vibrating feeder main body 1, it is possible to operate while performing the resonance point follow-up control as described below using the above-described principle.

First, when driving of the vibrating feeder main body 1 is started by the control apparatus 2, the frequency setting unit 32 reads the preset initial setting frequency f0 set in the storage unit 31 and outputs it as a drive frequency f to the PWM signal generation unit 33. The PWM signal generation unit 33 generates and outputs a PWM signal corresponding to the drive frequency f. The PWM signal is amplified by the amplifier 4 and supplied to the electromagnetic drive unit De as a pseudo AC voltage. As a result, the movable body 12 is vibrated by the drive frequency f to be able to convey the work placed on the movable body 12 by the vibration. As the initial setting frequency f0, it is preferable to use a resonance frequency of the vibrating feeder main body 1 in a non-loaded state or a final value of the drive frequency f at the previous driving.

Then, after shifting to a steady operation at the drive frequency f, the first current change rate generation unit 35 calculates the current variation amount di at the minute time dt, which is obtained by subtracting the preset mask time Tm from the output time Tp (see FIG. 7, FIG. 8) of the voltage signal for one pulse at the preset first reference phase angle θ1, by the current detection value from the current detection unit 34, and generates the first current change rate R_{θ1} from these values. Similarly, the second current change rate generation unit 36 calculates the current change amount di at the minute time dt, which is obtained by subtracting the preset mask time Tm from the output time Tp of the voltage signal for one pulse at the preset second reference phase angle θ2, from the current detection value from the current detection unit 34, and generates the second current change rate R_{θ2} from these values.

The first and second reference phase angles θ1 and θ2 are required to be set within a range of ±90° with respect to the phase angle θp at which the pseudo AC voltage has a peak value. Further, if it is set within a range of ±45°, the width of one pulse voltage constituting the PWM signal can be sufficiently obtained, and it is more preferable to obtain a highly accurate current change rate R.

On the basis of the first and second current change rates R_{θ1}, R_{θ2} obtained by the first and second current change rate generation units 35, 36 as described above, the frequency correction unit 37 determines whether or not to correct the drive frequency f, and decides a frequency correction value if a correction is to be performed. Specifically, in accordance with the concept described in the lower part of FIG. 6, the frequency correction unit 37 calculates the current change rate difference rate ΔR, which is obtained by subtracting the absolute value |Rθ2| of the second current change rate from the absolute value |R_{θ1}| of the first current change rate, and determines whether the obtained current change rate difference θR falls within the range of −ΔRₜₕ or more and ΔRₜₕ or less set by the threshold ΔRₜₕ stored in the storage unit 31. When the current change difference is within this range, an output that makes the frequency correction value zero is made to the frequency setting unit 32, and the frequency setting unit 32 does not correct the drive frequency f. Further, when the current change rate difference ΔR is less than −ΔRₜₕ, the frequency correction amount Δf per one time stored in the storage unit 31 is outputted to the frequency setting unit 32 as a frequency correction value, and the frequency setting unit 32 makes a correction to update the drive frequency f to f+Δf. When the current change rate difference ΔR exceeds ΔRₜₕ, the frequency correction amount Δf per one time stored in the storage unit 31 is outputted to the frequency setting unit 32 as a frequency correction value, and the frequency setting unit 32 makes a correction to update the drive frequency f to f−Δf.

Although the threshold value ΔRₜₕ is set to be about 10% of the first current change rate R_{θ1}, it may be smaller than this value. Further, the threshold value ΔRth may be obtained by calculation from the obtained first current change rate R_{θ1}. Further, the correction amount of the drive frequency f may be obtained by calculation to change in accordance with the magnitude of the current change rate difference ΔR.

Although the correction of the drive frequency f as described above is made for each cycle of the pseudo AC voltage, the correction may be made at an appropriate timing such as every 10 cycles.

By controlling the vibrating feeder main body 1 by using the control apparatus 2 in this way, even if the resonance frequency changes due to factors such as a weight change or unbalance of a work or a change with time of the characteristics of the leaf spring 13, etc., it is possible to largely vibrate the movable body 12 with less energy by changing the drive frequency f to follow the resonance frequency change thereby properly conveying the work.

As described above, the vibrating feeder control apparatus 2 according to the present embodiment is used to drive the vibrating feeder main body 1 comprising the base 11, the movable body 12 elastically supported by the base 11, the electromagnet 14 provided on the base 11, and the magnetic core 15 provided on the movable body 12 to oppose to the electromagnet 14. The vibrating feeder control apparatus includes a PWM signal generation unit 33 that generates a PWM signal based on a set drive frequency f and applies a pseudo AC voltage corresponding to the PWM signal to the electromagnet 14, a current detection unit 34 that detects a current flowing in the electromagnet 14 by the pseudo AC voltage, current change rate generation units 35, 36 that generate current change rates R_{θ1}, R_{θ2} at predetermined reference phase angles θ1, θ2 within a cycle of the pseudo AC voltage based on the detection value by the current detection unit 34, and a frequency correction unit 37 that corrects the drive frequency f based on the current change rates R_{θ1}, R_{θ2} at the reference phase angles θ1, θ2 obtained by the current change rate generation units 35, 36.

As being configured as described above, a pseudo AC voltage corresponding to the PWM signal generated by the PWM signal generation unit 33 is applied to the electromagnet 14, and in a minute time, a pulse-like constant voltage is applied to the electromagnet 14. When a constant voltage is applied to the electromagnet 14 as described above, the current change rate R (=di/dt) that is a gradient of a current flowing in the electromagnet 14 corresponds to the inductance L of the electromagnet 14. Since the inductance L corresponds to the gap lg between the electromagnet 14 and the magnetic core 15, in other words, the displacement amount of the movable body 12, obtaining the current change rate R means the same as knowing the displacement amount of the movable body 12 at that time. Therefore, the current change rate generation units 35 and 36 generate the current change rates R_{θ1} and R_{θ2} at the predetermined reference phase angles θ1 and θ2, and the frequency correction unit 37 corrects the drive frequency f based on the current change rates R_{θ1} and R_{θ2}, whereby it is possible to control the drive frequency f at which a phase difference between the voltage and the displacement becomes a predetermined relationship, ie, a phase difference of 180°, without using a displacement sensor for detecting the displacement of the movable body 12.

Further, the first reference phase angle θ1 and the second reference phase angle θ2 are set as the reference phase angles θ1, θ2 at substantially symmetrical positions around the peak phase angle θp that is a phase angle at which a peak value of the pseudo AC voltage is generated, the first current change rate generation unit 35 that generates the first current change rate R_{θ1} corresponding to the first reference phase angle θ1 and the second current change rate generation unit 36 that generates the first current change rate R_{θ2} corresponding to the second reference phase angle θ2 are provided as the current change rate generation units 35, 36, and the frequency correction unit 37 is configured to correct the drive frequency f based on the first and second current change rates R_{θ1}, R_{θ2} obtained from the first and second current change rate generation units 35, 36. Therefore, the drive frequency f can be corrected based on the two current change rates R_{θ1}, R_{θ2} obtained at positions substantially symmetrical around the peak phase angle θp so that the drive frequency f for driving the vibrating feeder main body 1 can be controlled with a higher accuracy.

Furthermore, the current change rate generation units 35, 36 are configured to generate the current change rates R_{θ1}, R_{θ2} during the period from turn on to turn off of the PWM signal for one pulse corresponding to the first and second reference phase angles θ1 and θ2. Therefore, it is possible to accurately generate the current change rates R_{θ1} and R_{θ2} when a constant voltage is being applied and it is possible to make the control more easily.

Still further, the current change rate generation units 35, 36 generate the current change rates R_{θ1}, R_{θ2} during the period from turn on of the PWM signal for one pulse corresponding to the first and second reference phase angles θ1 and θ2 to turn off after the mask time Tm that is a predetermined time has elapsed. Therefore, it is possible to obtain the current change rates R_{θ1}, R_{θ2} more accurately by avoiding the influence of a response delay immediately after the switching.

Further, the first and second reference phase angles θ1, θ2 are set within a range of ±90° around the peak phase angle θp at which a peak value of the pseudo AC voltage occurs, the frequency correction unit 37 is configured not to correct the drive frequency f when the current change rate difference ΔR obtained by subtracting the absolute value |R_{θ2}| of the second current change rate from the absolute value |R_{θ1}| of the first current change rate is in a predetermined range of −ΔRₜₕ to Rₜₕ, and correct the drive frequency f in a decreasing direction when the current change rate difference ΔR exceeds a predetermined range, that is, when it exceeds ΔRₜₕ, and correct the drive frequency f in an increasing direction when the current change rate difference ΔR is smaller than a predetermined range, that is, when it is lower than −ΔRₜₕ. Therefore, it is possible to easily determine whether the drive frequency f is substantially equal to the resonance frequency, or is large or small when the drive frequency f is deviated, and it is possible to easily correct the drive frequency f to be closer to the resonance frequency, and it is possible to suitably realize the resonance point follow-up control.

By configuring as a vibrating feeder Fv comprising the vibrating feeder control apparatus 2 and the vibrating feeder main body 1 controlled by the vibrating feeder control apparatus 2 as described above, it is possible to suitably perform the resonance point follow-up control without requiring a displacement sensor, and it is possible to realize an inexpensive vibrating feeder Fv with simple wiring and high reliability.

The specific structure of each part is not limited only to the embodiments described above.

Specifically, in the embodiment described above, the electromagnets 14 constituting the electromagnetic drive unit De is provided on the base 11 side and the magnetic core 15 is provided on the movable body 12 side, but contrary to this, the electromagnets 14 may be provided on the movable body 12 side and the magnetic core 15 may be provided on the base 11 side.

In the embodiment described above, a pseudo AC voltage is applied to flow a current only in one direction to the electromagnet 14, but a current may flow while changing to positive and negative, even in this case, the effect similar to the above can be obtained.

Furthermore, in the embodiment described above, the drive frequency f is controlled to coincide with the resonance frequency. However, depending on the characteristics of the vibrating feeder main body 1, the drive frequency f may be slightly shifted from the resonance frequency to obtain control stability. In that case, it is preferable that the first and reference phase angles θ1, θ2 are not set to positions completely symmetrical with respect to the peak phase angle θp but are set to slightly shifted positions. By doing like this, it is possible to perform control by setting the phase difference between voltage and displacement to a predetermined relationship slightly shifted from 180°.

In the above embodiment, the vibrating feeder Fv is configured as a linear feeder, but it may be configured as a bowl feeder as disclosed in Patent Document 2. Similarly to the above, as long as the electromagnetic drive unit De is provided in the vibrating feeder main body 1, the same effect can be obtained by using the control apparatus 2 with the same configuration as described above.

Various modifications are possible in other configurations without departing from the gist of the present invention.

### DESCRIPTION OF REFERENCE NUMERALS

1 Vibrating feeder main body

2 Vibrating feeder control apparatus

11 Base

12 Movable body

14 Electromagnet

15 Magnetic core

33 PWM signal generation unit

34 Current detection unit

35 First current change rate generation unit

36 Second current change rate generation unit

37 Frequency correction unit

f Drive frequency

Fv Vibrating feeder

Δf Frequency correction amount per one time

L Inductance

R Current change rate (=di/dt)

R_{θ1} First current change rate

R_{θ2} Second current change rate

ΔR Current change rate difference

ΔRₜₕ Threshold value of current change rate difference

Tm Mask time

θ1 First reference phase angle

θ2 Second reference phase angle

θp Peak phase angle

1. A vibrating feeder control apparatus used for driving a vibrating feeder main body comprising a base, a movable body elastically supported by the base, an electromagnet provided on one of the base and the movable body, and a magnetic core provided on the other of the base and the movable body to oppose the electromagnet, the control apparatus comprising:
a PWM signal generation unit that generates a PWM signal based on a set drive frequency and applies a pseudo AC voltage corresponding to the PWM signal to the electromagnet;
a current detection unit that detects a current flowing in the electromagnet by the pseudo AC voltage;
a current change rate generation unit that generates a current change rate at a predetermined reference phase angle within a cycle of the pseudo AC voltage based on a detection value of the current detection unit, and
a frequency correction unit that corrects the drive frequency based on a current change rate at a reference phase angle obtained by the current change rate generation unit.

2. The vibrating feeder control apparatus according to claim 1, wherein:
a first reference phase angle and a second reference phase angle are set as the reference phase angle at positions that are substantially symmetrical around a phase angle at which a peak value of the pseudo AC voltage occurs,
a first current change rate generation unit that generates a first current change rate corresponding to the first reference phase angle, and a second current change rate generation unit that generates a second current change rate corresponding to the second reference phase angle are provided as the current change rate generation unit, and
the frequency correction unit corrects the drive frequency based on the first and second current change rates obtained from the first and second current change rate generation units.

3. The vibrating feeder control apparatus according to claim 2, wherein
the current change rate generation unit generates the current change rate during a period from turn-on to turn-off of the PWM signal for one pulse corresponding to the first and second reference phase angles.

4. The vibrating feeder control apparatus according to claim 3, wherein
the current change rate generation unit generates the current change rate during a period from turn-on of the PWM signal for one pulse corresponding to the first and second reference phase angles to turn-off after a lapse of predetermined time.

5. The vibrating feeder control apparatus according to claim 2, wherein:
the first and second reference phase angles are set within a range of ±90° around a phase angle at which a peak value of the pseudo AC voltage occurs, and
the frequency correction unit does not correct a drive frequency when a current change rate difference obtained by subtracting an absolute value of the second current change rate from an absolute value of the first current change rate is within a predetermined range including a zero therebetween, and corrects the drive frequency in a decreasing direction when the current change rate difference exceeds the predetermined range, and corrects the drive frequency in an increasing direction when the current change rate difference is smaller than the predetermined range.

6. The vibrating feeder control apparatus according to claim 3, wherein:
the first and second reference phase angles are set within a range of ±90° around a phase angle at which a peak value of the pseudo AC voltage occurs, and
the frequency correction unit does not correct a drive frequency when a current change rate difference obtained by subtracting an absolute value of the second current change rate from an absolute value of the first current change rate is within a predetermined range including a zero therebetween, and corrects the drive frequency in a decreasing direction when the current change rate difference exceeds the predetermined range, and corrects the drive frequency in an increasing direction when the current change rate difference is smaller than the predetermined range.

7. The vibrating feeder control apparatus according to claim 4, wherein:
the first and second reference phase angles are set within a range of ±90° around a phase angle at which a peak value of the pseudo AC voltage occurs, and
the frequency correction unit does not correct a drive frequency when a current change rate difference obtained by subtracting an absolute value of the second current change rate from an absolute value of the first current change rate is within a predetermined range including a zero therebetween, and corrects the drive frequency in a decreasing direction when the current change rate difference exceeds the predetermined range, and corrects the drive frequency in an increasing direction when the current change rate difference is smaller than the predetermined range.

8. A vibrating feeder comprising a vibrating feeder control apparatus according to claim 1, and a vibrating feeder main body controlled by the vibrating feeder control apparatus.
